(19) United States
(12) Patent Application Publication
(10) Pub. No.: US 2014/0067673 A1
(43) Pub. Date: Mar. 6, 2014

(54) TRUSTED USER INTERFACE AND TOUCHSCREEN

(71) Applicant: Mads Lanrok, San Jose, CA (US)

(72) Inventor: Mads Lanrok, San Jose, CA (US)

(21) Appl. No.: 13/604,604

(22) Filed: Sep. 5, 2012

(51) Int. Cl. G06Q 20/40

(52) U.S. Cl. CPC G06Q 20/4016
USPC 705/44

(57) ABSTRACT

A method for preventing a user from being lured into an electronic transaction that is different than one they intended to launch uses a transaction processor to encrypt a payment instruction message for private display and viewing by a user mobile electronics device. The mobile electronics device is configured to forward an encrypted payment instruction from the transaction processor to decoding and display circuitry secure from other access and reserved to the display of decoded payment instructions on a private display. The user is signaled when the private display is presenting a payment instruction from the transaction processor. The user is able to signal back to the transaction processor that the payment instruction is approved. Electronic transactions can only be completed if the user has signaled back to the transaction processor that the payment instruction is approved.

### BACKGROUND OF THE INVENTION

1. Field of the Invention

The present invention generally relates to electronic transactions, and more particularly to systems and methods that interact with the user and summarize what it is the users will be authorizing by accepting the present transaction.

2. Background of the Invention

Some financial transactions, especially those only 10-20 years ago were like putting a message in a bottle to your bank in San Francisco, tossing it in the waters off Honolulu, and hoping it gets there without interception. Conventional credit cards and debit cards pretty much did that, you signed for the purchase and hoped the statement that arrived more than a month later reflected what you had actually authorized. Most Americans don't even check, perhaps because the sales receipt was misplaced or their memories had faded.

The trouble that developed was fraudsters would get in between users and their cards, in between cards and their banks, and in between banks and their transaction processors. All along the line the only one with firsthand knowledge of what the transaction is supposed to be was the user. But conventional systems failed to rely on the user to keep the particulars in check.

Playing the man-in-the-middle (MITM) is not so difficult when there is only one channel of communication and only one middle through which the transactions must pass. The attacker captures independent connections with victims on both ends, and relays apparently genuine messages between them. Each victim believes they are connected directly to each other because the messages seem timely and the content is about what is expected. But in fact, the conversation is completely controlled by the attacker. The challenge here is the attacker must be able to intercept all messages going between the victims and be quick enough to inject substitute messages that can further the fraud without detection.

Man-in-the-middle attacks can only succeed when the attacker can credibly impersonate each endpoint to the satisfaction of the other. It therefore is an attack on mutual authentication. Cryptographic protocols usually include some form of endpoint authentication to prevent MITM attacks. For example, secure socket layer (SSL) can authenticate one or both parties using a mutually trusted certification authority.

In order for cryptographic systems to be secure against MITM attacks, an additional exchange or transmission of information needs to be made over some kind of secure channel. The so-called Interlock Protocol is a method used to counter a middle-man who might try to compromise two parties that use anonymous key agreement to secure their conversations.

The impersonations that are now becoming commonplace are so good it's hard to tell who or what to trust. Citibank right now is trying to fight back on its CitiBusiness Online website, e.g., https://businessaccess.citibank.citigroup.com/cbusol/signon.do. They are posting notices that read:

TABLE I

BE AWARE: EMAIL SCAMS
Be aware of any email that purports to be from a financial
institution, NACHA, IRS, FDIC, Federal Reserve Board, UPS,
Federal Courts or other agencies. Do not follow links in these
emails. They are most likely scams designed to alarm you and
trick you into following links that facilitate the download of
malware to your PC.
PROTECT YOUR ACCOUNTS
Employ dual approval for wires, bill payments, ACH transactions
and payroll transactions.
Check account activity daily to ensure that there are no
unauthorized transactions.
EDUCATE YOUR ONLINE USERS:
Do not respond to unsolicited e-mail.
Do not click on links contained within an unsolicited e-mail.
Be cautious of e-mail claiming to contain pictures in attached
files, as the files may contain viruses. Only open attachments
from known senders. Scan the attachments for viruses if possible.
Avoid filling out forms contained in e-mail messages that ask
for personal information.
Log directly onto the official website for the business
identified in the e-mail, instead of “linking” to it from an
unsolicited e-mail.
Contact the actual business that supposedly sent the e-mail to
verify if the e-mail is genuine.
If you are asked to act quickly, or there is an emergency, it
may be a scam. Fraudsters create a sense of urgency to get you
to act quickly.
PROTECT YOUR COMPUTER AND NETWORK
Install and use up-to-date anti-virus and anti-spyware software.
Install routers and firewalls to prevent unauthorized access to
your computer or network.
Install security updates to operating systems and all
applications as they become available.
Block pop-ups.
Use current versions of browsers as they contain advanced
security features.
Install, use and maintain spam filters.

Risks are always involved when a user authorizes financial or legal value transactions on a connected phone, a tablet, a PC, or other an open device. There is always the risk that the user will be drawn into accepting a different transaction than the one they intended to enter. A risk to the other side is that the user may try to disown or repudiate a transaction for various reasons, e.g., regret, mistake, or fraud.

Users would like to think they can trust the keyboards and displays of the personal trusted devices they keep in their pockets. But that is more and more not the case. Fraudsters are finding ways to highjack these keyboards and displays for their own nefarious purposes. The displays of given devices can no longer be trusted to display only the transaction that the user ought to be presented with.

### SUMMARY OF THE INVENTION

Briefly, a method of the present invention for preventing a user from being lured into an electronic transaction that is different than one they intended to launch uses a transaction processor to encrypt a payment instruction message for private display and viewing by a user mobile electronics device. The mobile electronics device is configured to forward an encrypted payment instruction from the transaction processor to decoding and display circuitry secure from other access and reserved to the display of decoded payment instructions on a private display. The user is signaled when the private display is presenting a payment instruction from the transaction processor. The user is able to signal back to the transaction processor that the payment instruction is approved. Electronic transactions can only be completed if the user has signaled back to the transaction processor that the payment instruction is approved.

These and other objects and advantages of the present invention will no doubt become obvious to those of ordinary skill in the art after having read the following detailed description of the preferred embodiments that are illustrated in the various drawing figures.

### IN THE DRAWINGS

FIG. 1 is a perspective view diagram of a laptop computer showing how a portion of the display screen can be reserved for secure messages from a secure backend server to a user;

FIG. 2 is a functional block diagram of a user computer system includes a graphics display with a reserved area for a payment instruction (PI) from a secure backend transaction processor with access over a network;

FIG. 3 is a functional block diagram of a payment authentication system in an embodiment of the present invention similar in operation to the user computer system shown in FIG. 2, but here the payment authentication system is implemented as a cable box or module that plugs between a conventional user graphics display and a mobile computing device;

FIG. 4 is a functional block diagram of a another payment authentication system in an embodiment of the present invention;

FIG. 5 is a flowchart diagram of a method embodiment of the present invention;

FIGS. 6A-6D represent a scramble PIN pad at four different times but with the same PIN code entry causing four different coordinates results;

FIG. 7 is a diagram of a mobile phone displaying a scramble PIN pad template on a non-touch user display, the presentation is sent in realtime and used as a guide for which hard keys to press for entry of a PIN code; and

FIG. 8 is a diagram of a middle portion of a typical soft keyboard displayed on a touchscreen for user entry of their PIN through a scramble PIN pad. Here, keyboard letters R-T-Y-F-G-H-V-B-N will be respectively interpreted by the system as user PIN numbers 3-9-1-5-7-6-8-4-2 when touched.

### DETAILED DESCRIPTION OF THE PREFERRED EMBODIMENTS

Secure backend display embodiments of the present invention use private display hardware to guarantee to users that the message displays they see are trustworthy. One method involves providing a completely separate device or new function with a secure display from a server backend. Encrypted messages are channeled so that they can only be decoded in the final stages of circuitry by private display hardware. The messages never pass in the clear through shared software or hardware like operating systems, communications sessions, display controllers or user displays. Trusted messages are never allowed to reach the provided displays.

It then becomes simple for the user to understand and trust that messages that appear in these special displays are secure and reliable. Another method embodiment of the present invention reserves a small area of an existing display for the delivery of secure messages through an auxiliary controller that does its own private message decryption. Both methods allow a user to control or validate with high confidence that a secure mode is present.

Authenticated messages can be communicated from back-end servers over the network to user display controllers in their personal devices. Once the message authenticity and integrity has been validated through decryption, or message authentication, the local display controller makes it obvious to the user that a secure mode is established. An authenticated message from the secure back-end, e.g., a payment instruction, is presented by the display controller.

In one embodiment, represented in FIG. 1, a laptop 100 has its lower right corner 102 of a display 104 reserved for authenticated messages (PI) from back-end servers. A touchscreen type of display 104 is advantageous for the entry of PIN numbers, otherwise a hard keypad can be usefully employed. Markers along-side the screen may be used delineate the area for visual inspection by the user. A control mechanism 105, accessible to the user provides a private, direct input connection to an internal display controller. A separate indicator 106 has a private, direct data output connection from the display controller.

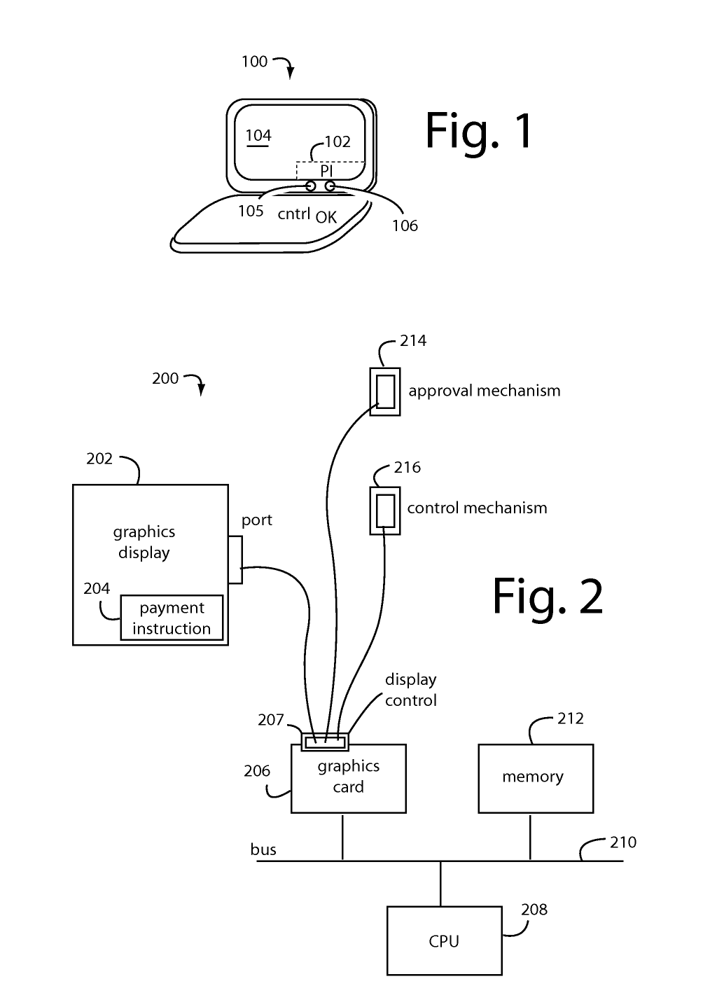

FIG. 2 provides a bit more detail. A user computer system 200 includes a graphics display 202 with a reserved area 204 for a payment instruction (PI) from a secure backend transaction processor with access over a network. A graphic card 206 is conventional except for its ability to directly receive encrypted messages, decode them, and display the message contents in the reserved area 204. A display control 207 can be embedded in a connecting cable.

For example, graphic card 206 can provide a data I/O port or address in memory space that can be written by a CPU 208 over a system bus 210. Alternatively, encrypted messages can be written to a memory 212 and graphic card 206 is signaled to collect the message.

Data transactions occurring over bus 210 are not secure, so messages between the graphic card 206 and the secure backend transaction processor must be encrypted and decrypted by the graphic card 206 without any help or visibility by the rest of the user computer 200. Encrypted messages arriving at user computer 200 are routed to graphic card 206, and there they are simply decrypted and displayed without condition or interpretation. If the original encryption was legitimate, a proper payment instruction or other message will be presented and read by the user. Otherwise, the decrypted message will be garbage.

Messages, such as user approvals, can be encrypted into data payloads that are deposited in memory 212 for delivery by CPU 208 to the secure backend server.

An otherwise hidden logo can be lit up to clearly indicate to the user that a secure mode is currently established. Control mechanisms can include switches used to force secure mode exhibitions onto the display.

Sensitive portions of display controllers can be implemented by tamper resistant hardware that is uniquely identifiable using cryptographic techniques. For example, a public key pair in which the public key was pre-registered and that can read out from the device. The private key is only available for use inside the controller and cannot be read out or copied.

Display controllers can be provisioned with the public keys of trustworthy back-ends, or the root certificate of a certification authority (CA) trustworthy back-ends, or keys reserved by the device controller manufacturers. Derived or pre-shared secret symmetric key schemes may be used when asymmetric cryptographic techniques cannot be supported.

Embodiments of the present invention include an approval mechanism in the device, e.g., a discrete push button, display touch button, or other manually operated input with a private connection to the display controller or a soft keypad displayed on a touchscreen. Such are pressed in secure mode to indicate an approval by the user, e.g., an authenticated message is sent back over the network from the device to the secure back-end. In other cases, the user may approve the transaction messages using secondary channels like SMS.

Some embodiments of the present invention allow secondary devices to be used to validate authentication messages. Users can initiate or otherwise launch a transaction at a point of sale (POS) terminal, and the POS terminal's display may be recruited to confirm the transaction to the user.

In instances where users are nowhere near POS terminals, e.g., in an Internet-based transaction, one device can be used to carry out banking transactions, while an app on another device is used to validate the particulars of those transactions.

User may receive confirmation messages or payment instructions related to a transaction being attempted. These confirmation messages or payment instructions may appear on SMS, email, interactive voice response (IVR), or other side channels. A typical message to the user would say, “by keying in ‘43562’ you acknowledge you are transferring 10,000 USD to account XYZ with SWIFT or ABA code ABC”. So if ‘43562’ is keyed in by the user and received back, then the system is sure the real user understands and approves the correct transaction and its particulars. Such acknowledgements would be impossible to renounce later.

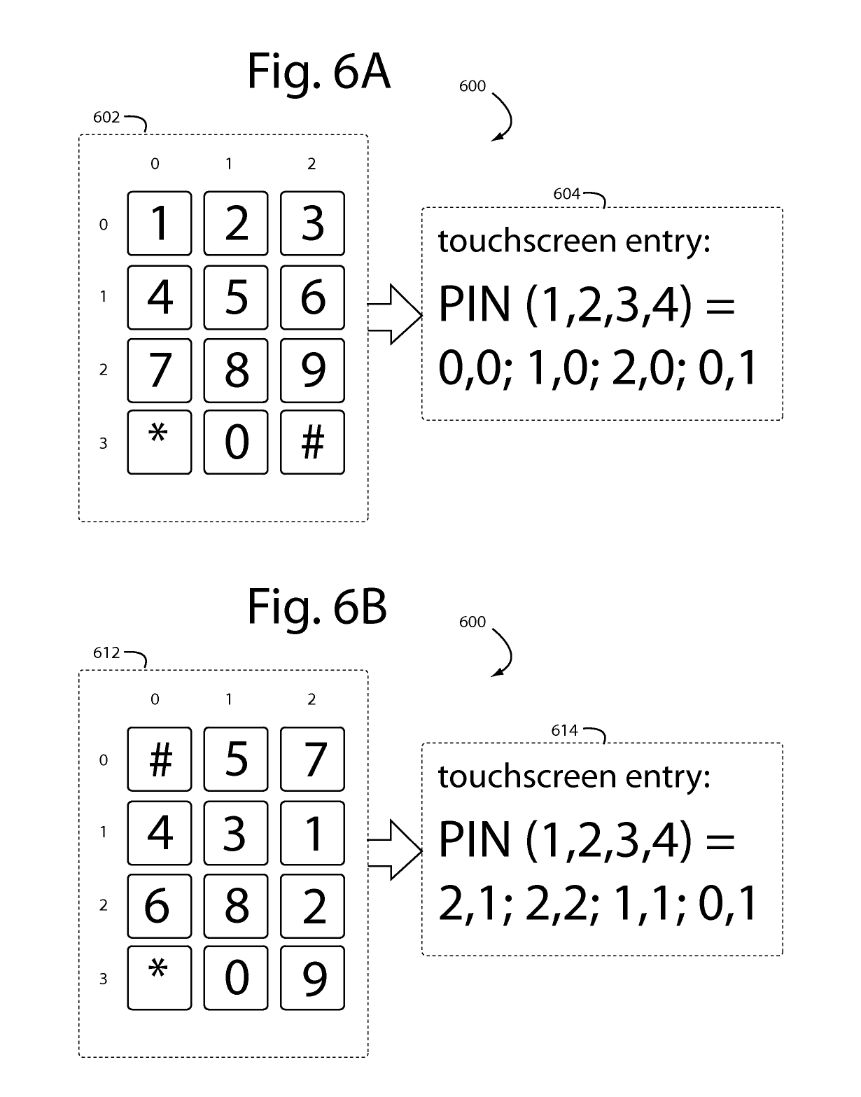

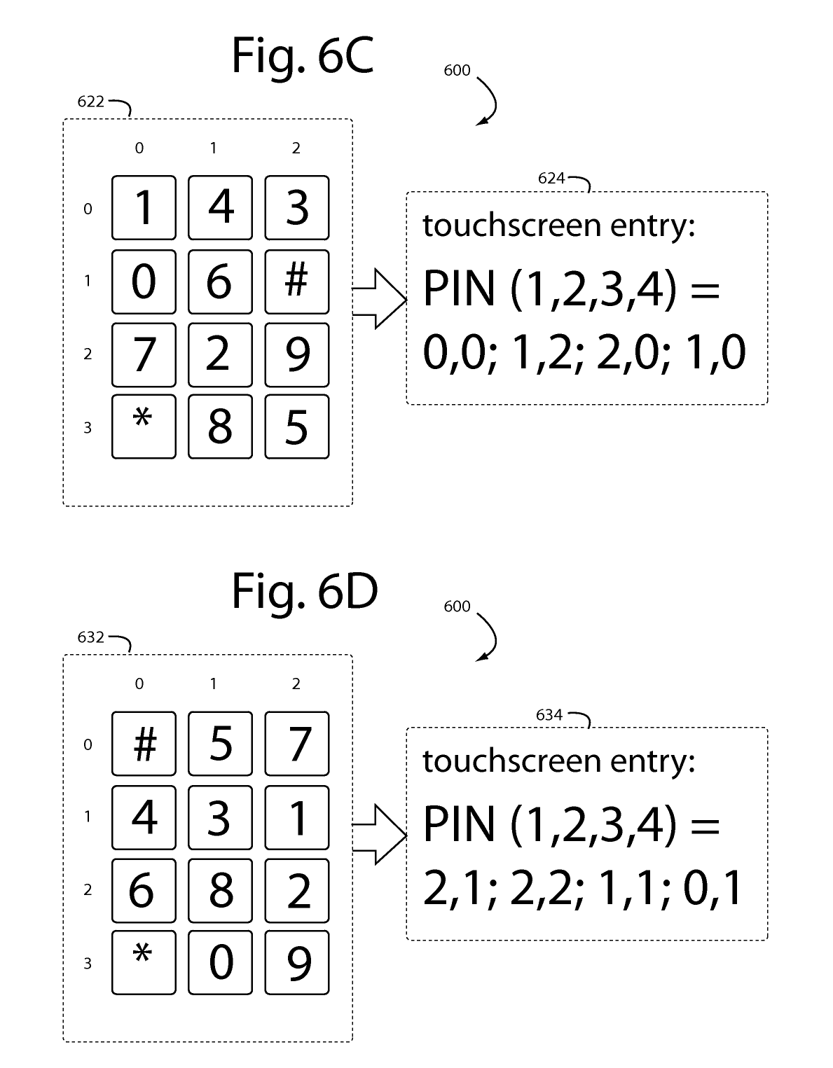

Alternatively, the user could show their understanding with a simple OK pushbutton, or a PIN entry at a scramble PIN pad as is described in FIGS. 6A-6D, 7, and 8.

Embodiments of the present invention all provide a trusted graphical user interface (TGUI) for reliance by the user in all transactions. All the middlemen are excluded on the back channel and so what is presented on the TGUI is straight from the transaction processor. This allows for What You See is What You Authorize, What You See is What You Sign (WYSIWYS),and What You See is What You Get (WYSIWYG) modes of operation.

When authorizing financial or legal value-transactions on an open device there is always the risk that a user may be lured into accepting a different transaction than the one they intended one. Another risk (to the bank) is a user may try to disown or repudiate a transaction for various reasons, e.g. regret or worse.

The displays of most devices in the hands of users cannot be trusted. To combat this, graphics controllers, or the cable between a device screen and its graphics controller, can be enhanced to be more secure. In one embodiment, the display controller is embedded in a connecting cable between the display and peripheral controller. In another embodiment, it is buried in tamper resistant hardware that is uniquely identifiable using cryptographic techniques preferably a public key pair of which in some embodiments the public key was certified before the device was delivered to the customer and which can read out from the device whilst the private key is available inside the controller only and cannot be read out nor copied.

Additionally, in some embodiments (and preferably before reaching the consumer) the display controller is furnished with the public key of a trustworthy back-end or even the root certificate of a CA (certification authority) trustworthy back-ends, preferably operated by the device controller manufacturer or other trustworthy body.

In embodiments where asymmetric cryptographic techniques cannot be supported derived or pre-shared secret symmetric key schemes may be used.

Each device is fitted with an approval mechanism, e.g., a separate push button, touch button, or other form of manually operated input connected directly to the display controller. When such buttons are pressed whilst in secure mode, an authenticated message is sent over the network from the device mechanism to the back-end. For other cases the user may approve the message in a number of other, such as e.g. using secondary channels or display touchscreens.

In one embodiment, the user may use his device to initiate or facilitate a given transaction at a point of sales (POS) terminal and the display of the POS terminal may be used to confirm the transaction to the user.

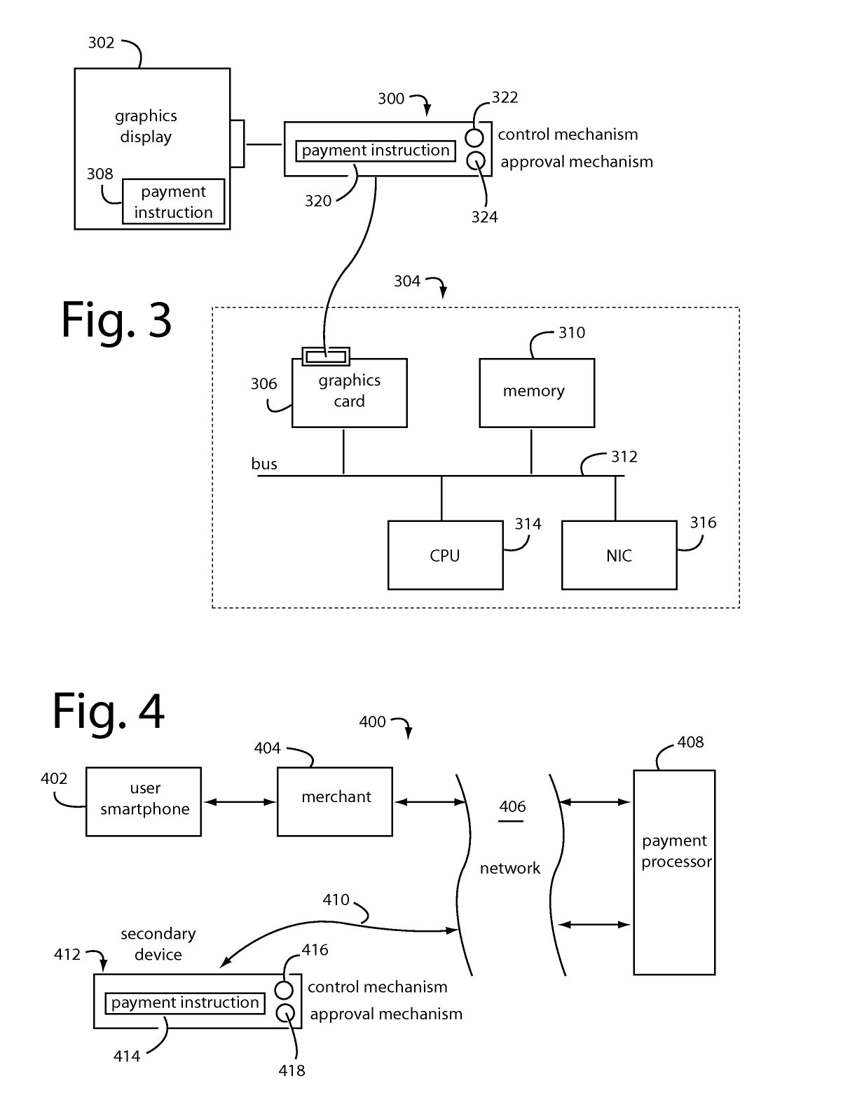

FIG. 3 represents a payment authentication system 300 in an embodiment of the present invention. While similar in operation to the user computer system 200 shown in FIG. 2, the payment authentication system 300 is implemented as a cable box or module that plugs between a conventional user graphics display 302 and a mobile computing device 304. A graphics card 306 delivers encrypted messages from remote network servers that simply comprise text strings once decoded. Payment authentication system 300 alone does such decoding and puts the text strings up in a reserved area 308 for private viewing by a user. Here, a payment instruction is decoded and presented in reserved area 308. Such payment instruction must make sense to the user given the activity the user is engaged in at the moment. A memory 310, a bus 312, a CPU 314, and a network interface controller (NIC) 316 are conventional.

Alternatively, a payment instruction 320 can be presented directly for the user on payment authentication system 300 cable box. The reserved area 308 would be unnecessary in such instance. A control mechanism 322, such as an indicator light, indicates when a secure message is present. An approval mechanism 324, such as a simple pushbutton, is employed by the user to signal an approval to a remote backend server. For example, to complete a transaction.

FIG. 4 represents another payment authentication system in an embodiment of the present invention, referred to herein by the general reference numeral 400. Payment authentication system 400 provides a secure way for a smartphone 402 engaged in a transaction with a merchant 404 over a network 406 and a payment processor 408 to complete the transaction that is intended by the user. When the payment processor 408 has all the details of the proposed transaction assembled, it identifies the pre-registered user involved and sends a verification message 410 back through network 406 to a secondary device 412. The user may receive a confirmation of the message attempted carried out of a different channel, such as e.g. SMS, Email, IVR, or similar. For example, “By keying in 43562 you acknowledge transferring 10,000 USD to account XYZ with SWIFT or ABA code ABC”.

A pre-registration process conducted earlier has established that user smartphone 402 and secondary device 412 are related to the same user. A payment instruction 414 is presented directly for the user. A control mechanism 416, such as an indicator light, indicates when a secure message is present. An approval mechanism 418, such as a simple pushbutton, is employed by the user to signal an approval to a remote backend server, e.g., payment processor 408, to complete a transaction.

Secondary device 412 can comprise any number of ordinary or special purpose devices intended for other applications or just this one. For example, the Pebble iPhone watch will connect to Apple iOS or Android devices via Bluetooth, while also running certain apps on its own platform.

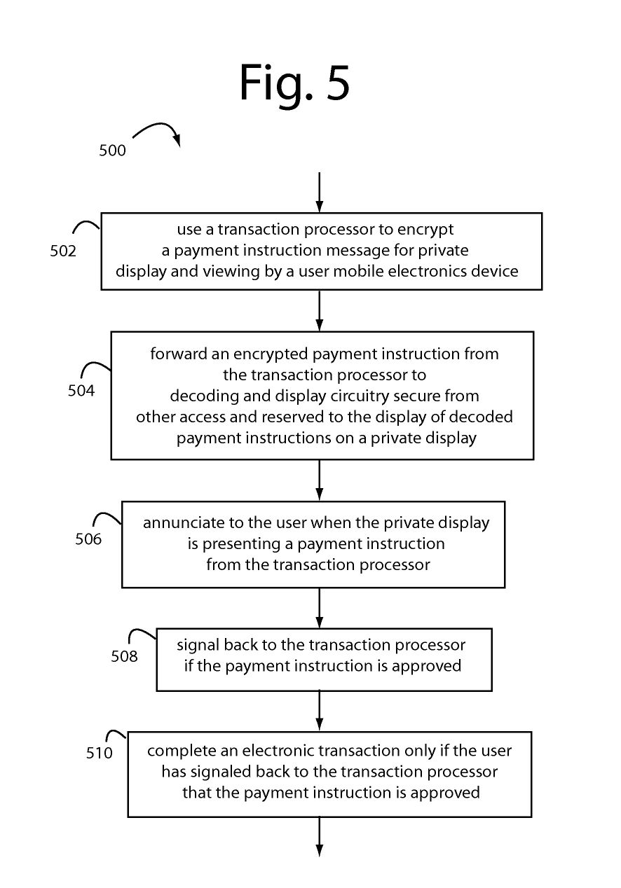

FIG. 5 represents a method for preventing a user from being lured into an electronic transaction that is different than one they intended to launch, in an embodiment of the present invention herein referred to by the general reference numeral 500. A step 502 uses a transaction processor to encrypt a payment instruction message for private display and viewing by a user mobile electronics device. In a step 504, the mobile electronics device is configured to forward an encrypted payment instruction from the transaction processor to decoding and display circuitry secure from other access and reserved to the display of decoded payment instructions on a private display. A step 506 annunciates to the user when the private display is presenting a payment instruction from the transaction processor. A step 508 enables the user to signal back to the transaction processor that the payment instruction is approved. A step 510 completes an electronic transaction only if the user has signaled back to the transaction processor that the payment instruction is approved.

In any embodiment of the present invention, users can be required to enter a PIN number in order to successfully complete a transaction. A soft PIN pad is typically presented on a touchscreen or other user display.

FIGS. 6A-6D represent a scramble PIN pad 600 at four different times, but with the same PIN code entry, 1-2-3-4, causing four different coordinates results. The presentations are randomized.

In FIG. 6A, a first touchscreen display 602 is presented to a user in realtime only long enough for the user to enter a PIN.

Here, the soft keypads have X,Y coordinates X:0-2 and Y:0-3. A PIN entry of 1-2-3-4 will produce a coordinate string 604 comprising: 0,0; 1,0; 2,0; 0,1. These could be communicated in the clear since their meaning is obtuse to interception, but they could also be encrypted for improved security. As an example, in a next session requiring user verification, FIG. 6B represents a second touchscreen display 612 where the soft keypads again have X,Y coordinates X:0-2 and Y:0-3, but the same user PIN entry of 1-2-3-4 will produce a coordinate string 614 comprising: 2,1; 2,2; 1,1; 0,1. FIG. 6C represents a third touchscreen display 622 where the soft keypads again have X,Y coordinates X:0-2 and Y:0-3, but a PIN entry of 1-2-3-4 will produce a coordinate string 624 comprising: 0,0; 1,2; 2,0; 1,0. FIG. 6D represents a third touchscreen display 632 where the soft keypads again have X,Y coordinates X:0-2 and Y:0-3, but a PIN entry of 1-2-3-4 will produce a coordinate string 634 comprising: 2,1; 2,2; 1,1; 0,1.

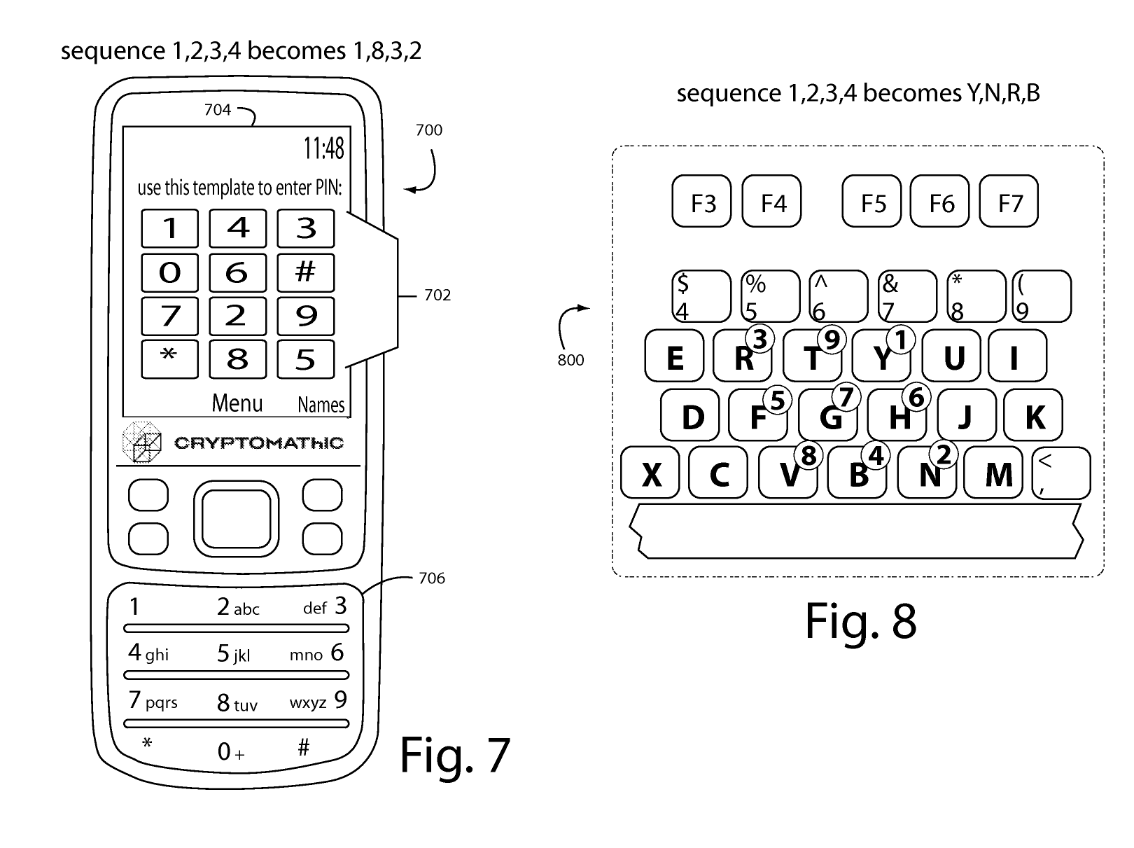

FIG. 7 represents a mobile phone 700 displaying a scramble PIN pad template 702 on a non-touch user display 704. Each presentation is sent in realtime and used as a guide to the user for which hard keys 706 to press for entry of a PIN code. Here, entry of PIN code 1-2-3-4 will have to be entered by the user on keypad 706 as 1-8-3-2. Each session will display a different, randomly arranged scramble PIN pad template 702 on non-touch user display 704.

FIG. 8 represents a middle portion of a typical soft keyboard 800 displayed on a touchscreen for user entry of their

PIN through a scramble PIN pad, represented by number bubbles superimposed over nine soft keys. Here, keyboard letters R-T-Y-F-G-H-V-B-N will be respectively interpreted by the system as user PIN numbers 3-9-1-5-7-6-8-4-2 when touched. Any key on the entire soft keyboard can be assigned a scramble PIN pad value, and those assignments should be dynamically reallocated with each session or use to maintain their value as a security feature.

In summary, it is of the utmost importance that the integrity of the confirmation messages returned to the user be maintained. It is of secondary importance to secure the message such that it cannot be viewed in realtime by others.

Although the present invention has been described in terms of the presently preferred embodiments, it is to be understood that the disclosure is not to be interpreted as limiting. Various alterations and modifications will no doubt become apparent to those skilled in the art after having read the above disclosure. Accordingly, it is intended that the appended claims be interpreted as covering all alterations and modifications as fall within the “true” spirit and scope of the invention.

What is claimed:

1. A transaction approval system, comprising:
a network based payments processing system configured to receive a user transaction request and to forward such request to a transaction processor for authentication and authorization;
a trusted graphical user interface private to a corresponding user and configured to present a payment instruction directly from said transaction processor to said user;
a control mechanism associated with the trusted graphical user interface and configured to announce to said user that a payment instruction is then being displayed on the trusted graphical user interface and that its source has been authenticated and its integrity validated; and
an approval mechanism associated with the trusted graphical user interface and control mechanism, and configured to signal back to the transaction processor that said user has approved the payment instruction then being displayed on the trusted graphical user interface.

2. The transaction approval system of claim 1, wherein said user is provided an opportunity to cancel a merchant transaction that is not being correctly described by the transaction processor in said payment instruction.

3. The transaction approval system of claim 1, wherein:
the trusted graphical user interface, the control mechanism, and the approval mechanism share the network communications configured to receive a user transaction request through a merchant and to forward such request to a transaction processor for authentication and authorization; and
the trusted graphical user interface, the control mechanism, and the approval mechanism use encryption to secure data and message exchanges in the parts of the network communications configured to be shared, and include private resources to decode, encode, and display said payment instruction and its associated controls and approvals.

4. The transaction approval system of claim 3, wherein:
the trusted graphical user interface, the control mechanism, and the approval mechanism are included within a personal trusted device (PTD);
the trusted graphical user interface uses at least a portion of a larger user graphics display to present said payment instructions;
the control mechanism is implemented as an indicator and is exclusively used to annunciate when a secure payment instruction is being displayed by the trusted graphical user interface; and
the approval mechanism is implemented as a momentary pushbutton, key, or scramble PIN pad and is reserved exclusively for said user to indicate a payment instruction currently being displayed by the trusted graphical user interface is approved.

5. The transaction approval system of claim 3, wherein:
the trusted graphical user interface, the control mechanism, and the approval mechanism are included in a second personal trusted device (PTD);
the trusted graphical user interface has its own dedicated user graphics display to present said payment instructions;
the control mechanism is implemented as an indicator and is exclusively used to indicate when a secure payment instruction is being displayed by the trusted graphical user interface; and
the approval mechanism is implemented as a pushbutton and is exclusively used to indicate said user has approved a payment instruction currently being displayed by the trusted graphical user interface.

6. A method for preventing a user from being lured into an electronic transaction that is different than one they intended to launch, comprising:
using a transaction processor to encrypt a payment instruction message for private display and viewing by a user with a mobile electronics device;
configuring the mobile electronics device to forward an encrypted payment instruction from said transaction processor to decoding and display circuitry secure from other access and reserved to the display of decoded payment instructions on a private display;
annunciating to said user when said private display is presenting a payment instruction from said transaction processor;
enabling said user to signal back to said transaction processor that said payment instruction is approved; and
completing an electronic transaction only if said user has signaled back to said transaction processor that said payment instruction is approved.
